(19) United States
(12) Patent Application Publication
(10) Pub. No.: US 2010/0110081 A1
(43) Pub. Date: May 6, 2010

(54) SOFTWARE-AIDED CREATION OF ANIMATED STORIES

(75) Inventors: Himanshu Arora, Hyderabad (IN); Kannan Ramasubramanian, Hyderabad (IN); Pranav Mistry, Ahmedabad (IN)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 12/261,906

(22) Filed: Oct. 30, 2008

(51) Int. Cl. G06T 15/70

(52) U.S. Cl. 345/473

(57) ABSTRACT

Software-assistance that allows a child or other author to generate a story. The author may generate their own content and add that author-generated content to the story. For instance, the author could drawn their own background, background items, and/or characters. These drawn items could even be added to a library so that they could be reused in other stories. The author can define their own animations associated with characters and background items, rather than selecting predefined animations. The story timeline may also keep track of events that are caused by the author interacting with the story in particular ways, and that represents significant story changes. The author may then jump to these navigation points to delete the event thereby removing the effects of the story change.

### BACKGROUND

Children love to be creative by drawing pictures and writing stories. There are even some computer programs that help children express their creativity. For instance MICROSOFT® Paint allows children to construct a static picture, whereas children sometimes want to express dynamic stories. There are software programs that allow children to generate storylines by selecting from pre-defined characters, background and animation.

For instance, two examples of web-based story creation programs are KERPOOF® and FUZZWICH™. Both of these web-based programs allow a user to select pre-defined backgrounds, and place pre-defined characters in those backgrounds. They also permit some amount of pre-defined animation of those characters. Sometimes that animation can be character-specific, but that animation is pre-defined for the child nevertheless, if even on a per-character basis. KERPOOF® allows the child to draw a character, upon which the program will associate some pre-defined set of animation types with that character that the user may select from. FUZZWICH™ does allow the child to drag a character along a certain path and speed, which during playback, will cause the character to follow that same path and speed.

As far as timeline navigation is concerned, in KERPOOF®, for example, a visual representation of a timeline is presented. The child drags a particular desired animation into that timeline, and can edit certain parameters of that animation, such as how long the animation is to take, or other animation-specific parameters. If the animation is to be further edited, the child must know where the visual representation of the animation is, and make appropriate parameter changes. The child can edit predefined parameters or pre-defined animations, as long as the child has some understanding of what a timeline is, how to correlate a timeline to a visual representation of the timeline, and how to interface with an abstract representation of an animation. This is something not all children interested in generating an animation would know how to do.

FUZZWICH™ also has a visual representation of a timeline. That timeline can include some events related to animation. To remove an animation, the child can click on the event in the timeline, and press a delete icon. If the child adds a new animation for a character, a new event appears in the timeline. However, many changes to the story are not represented as a visual event on the timeline. For instance, when a character begins and ends movement, that is not represented visually as an event.

### BRIEF SUMMARY

Embodiments described herein relate to the use of software to allow a child or other author to generate a story. In some embodiments, the author may generate their own content and add that author-generated content to the story. For instance, the author could draw their own background, background items, and /or characters. These drawn items could even be added to a library so that they could be reused in other stories. The author can define their own animations associated with characters and background items, rather than selecting pre-defined animations. In one embodiment, the story timeline keeps track of events that are caused by the author interacting with the story in particular ways, and that represents significant story changes. The author may then jump to these navigation points to delete the event thereby removing the effects of the story change.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates computing system in which one or more embodiments described herein may be employed;

FIG. 2 abstractly illustrates various components of an interactive story generation user interface 200;

FIGS. 3 illustrates a canvas editing mode of a user interface that represents an example of the user interface of FIG. 2;

FIG. 4 illustrates a character creation mode of the user interface of FIG. 3;

FIG. 5 illustrates a flowchart of a method for the computer-aided assistance in story generation using a story generation interactive user interface;

FIG. 6 illustrates a flowchart of a method for keeping track of interactive events;

FIG. 7 illustrates a flowchart of a method for registering an event and represents one example of the event registration of FIG. 6;

FIG. 8A illustrates a flowchart of a method for navigating through a timeline in response to a jump forwards navigation control activation; and

FIG. 8B illustrates a flowchart of a method for navigating through the timeline in response to a jump backwards navigation control activation.

### DETAILED DESCRIPTION

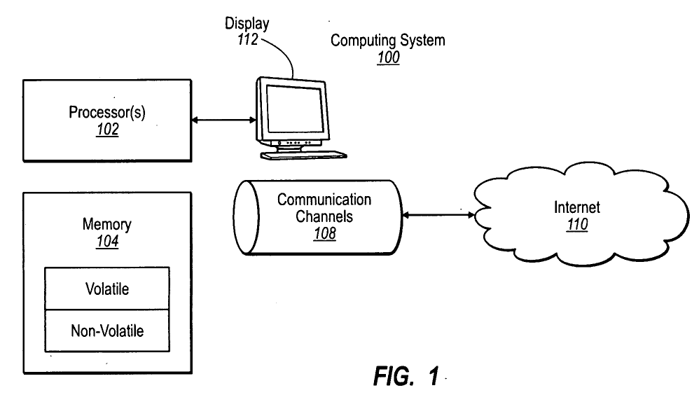

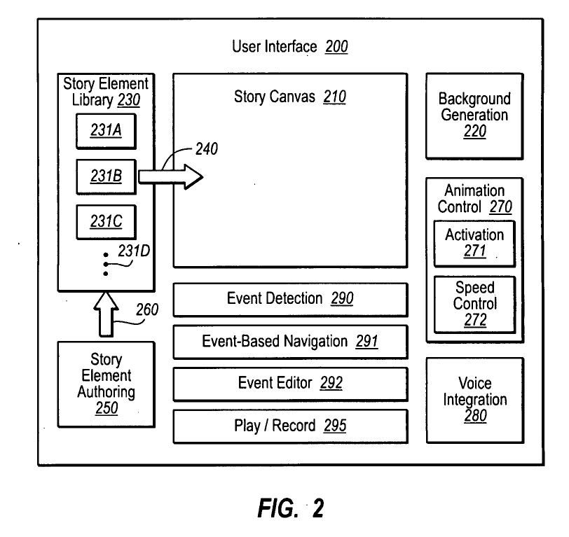

Embodiments described herein relate to the use of software to formulate stories. Children imagine stories that have particular characters, animation, backgrounds, voices, music and so forth, that the child might not feel is adequately expressed by pre-defined libraries of images, animation and sound. At least some embodiments described herein allow a child to express the story ideas in their heads in an easy-to-use and intuitive way. First, a computing system on which the software may execute will be described with respect to FIG. 1. Then, various embodiments of the story creation process will be described with respect to FIGS. 2 through 8B.

FIG. 1 illustrates a computing system 100. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processor 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100. Another example of such an operation is the display of information and interfaces on the display 1 12.

Computing system 100 may also contain communication channels 108 that allow the computing system 100 to communicate with other message processors over, for example, network 110 (such as perhaps the Internet). Communication channels 108 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term “computer-readable media” as used herein includes both storage media and communications media.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

Software may run on the computing system 100 that allows a child to create their own custom characters, animation, background, music, voice, and so forth. The software may be used to allow the child to create a story in a straightforward and intuitive manner. As an example, for custom animation, the user might intuitively create character animation by recording the movement of their characters in the story as they child drags and drops the character in a particular scene. The child might replay the animation exactly as it was recorded.

Also, the child might use an image editor to create additional characters to add to their library of available characters, or to create background scenery or elements to add to their library of background elements. The characters or scenery might be animated, for example using image frames in flip-book style animation. For instance, the child might simply press a record button, and move the characters against the background. To effect simultaneous movement of multiple characters, the child might simply just go back on the timeline and start moving the other characters along with the earlier set of moving characters. On top of this, the child could record his/her voice for narration or for character voice-overs. With very little effort, children and other creative authors can explore and express their creativity to the fullest. In one embodiment, the child could publish their stories on the Internet such that stories can be viewed by others.

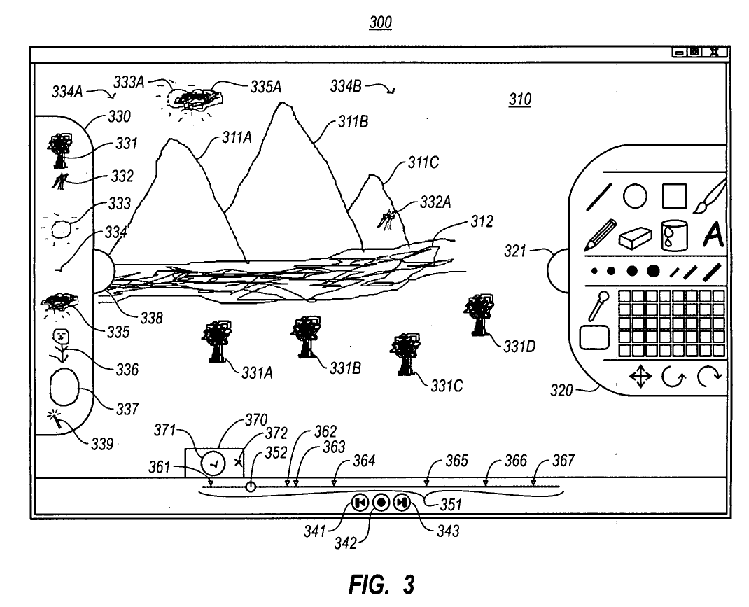

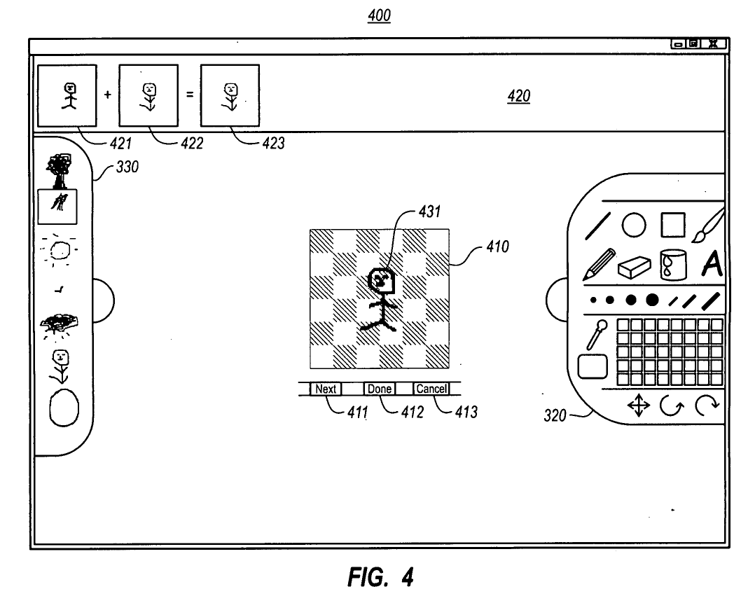

FIG. 2 abstractly illustrates various components of an interactive story generation user interface 200. Although only abstractly shown in FIG. 2, a more concrete representation of the interactive story generation user interface 200 may be displayed on a display 112 of the computing system 100 of FIG. 1. Each of the components of the user interface 200 will now be discussed in the abstract before describing a more concrete embodiment of such a user interface with respect to FIGS. 3 and 4.

The story canvas 210 is essentially the working area onto which the author (such as a child) may create and edit stories. There is no requirement that a single author generate the entire story. There might be several authors working in sequence that ultimately result in a particular story generated on the story canvas 210.

A background generation mechanism 220 allows an author to draw all or perhaps a portion of a background directly onto the story canvas. For instance, this might include a painting control that allows the user to draw lines of various thickness, fill in portions of the drawing with certain colors, and so forth. In one embodiment, the drawn background may be saved, allowing the author to draw another background for another portion of the story. Thus, during the course of the story, the background may change one or more times. For instance, scene 1 might be have a background of a drawing of a lion in a cage at the zoo. Scene 2 might have a background of a drawing of the front of the author's home. Scene 3 might have a background of a drawing of a jungle.

A story element library 230 includes a collection of reusable story elements. In this case, story elements 231A, 231B, 231C are shown. However, there might be other story elements as represented by the ellipses 231D. The story element library 230 is part of the user interface 200, and thus could be used for multiple stories. The story elements could be pre-generated, but also could be drawn by the author, or by another author (e.g., another child). The story elements could perhaps be made available over a network such that children can use the work of other children in the generation of their own stories. Artwork providers could also provide story elements. Even corporations might choose to make artwork available that let's children build stories using well-known characters.

The story elements could include characters or perhaps background items. For instance, a child-generated character might be a simple stick figure boy, a simple stick figure girl, a dragon, a lion, a smiling sun, a horse, or whatever else the child can image. A child-generated background item might be a lighthouse, a cloud, a windmill, a house, or any other item that the child wants to draw.

In one embodiment, the child could even generate multiple frames of a character, which when rendered in proper sequence, causes a type of flip book animation style in which movement (albeit perhaps choppy movement) may be simulated. For example, the child might animate a dragon flapping her wings by drawing first a dragon flying with her wings up, second the dragon flying with wings in mid-position, and third the dragon flying with wings in the down position. By rendering the animation using the first drawings, then the second drawing, then the third drawing, and then the second drawing, repeated, the flip book animation of the dragon is achieved by the child herself, with the computer only rendering the images in proper order to effect the animation.

A story element selection mechanism 240 permits an author to select one or more story elements from the story element library 230 to thereby copy that character onto the story canvas 210. Even so, the character remains in the library for use in other stories, or for perhaps replicated use in the same story. The selection mechanism 240 is represented as an arrow leading from the story element library 230 into the story canvas 210 representing that story elements may be added to the canvas using this selection mechanism 240.

A story element authoring mechanism 250 permits an author to generate reusable story elements. The mechanism 250 may be an expandable drawing area that allows the author to draw a picture of a character or background item. In addition to the drawing area, the story element authoring mechanism 250 might include a virtual paint pallet that allows the child to select drawing tool to render lines of various thickness, and to paint with particular colors.

A story element library addition mechanism 260 permits the author to add any story elements created in the story element authoring mechanism 250 to as reusable story elements to the story element library. The addition mechanism 260 is also represented as an arrow to represent the logic flow of author-generated story elements into the story element library 230.

An animation control mechanism 270 may also be present. This animation control mechanism may, for example, use an animation activation mechanism 271 for enabling and disabling the flip book style animation of the story character. For example, in the flip book style animated dragon example introduced above, while the dragon is flying, perhaps the author will activate the animation. However, when the dragon has landed, perhaps the author will deactivate the animation, causing only one of the images to appear, perhaps the image of the dragon with wings down. An animation speed control mechanism 272 may, for example, allow the speed of the animation to be adjusted. For example, the dragon may flap wings slowly while lowering, faster when hovering, and even faster when ascending.

A voice integration mechanism 280 allows an author to record his or her voice, and include that voice in any of the multiple stories. This could occur in real time when recording the story, or perhaps the author may pre-record his or her voice for later use with certain characters.

An events detection mechanism 290 detects when an author has engaged in any one of several user interaction types. These interaction types could be any interaction type that causes a story change. The events detection mechanism 290 may detect these events 290 automatically based on the user interaction even without the author knowing what events are, or that they are being generated. These events will represent discrete navigation points that the author may easily return to, in case the author wants to delete the effect of the story change caused by that event.

For example, the following occurrences might generate an event:
1) a new character appears on the canvas (for example, an author drags a character from the character library onto the canvas);
2) a character disappears from the canvas;
3) a character or background item starts an animation (such as a movement);
4) a character or background item stops an animation;
5) a character or background item has an animation speed change;
6) a background changes;
7) a character or background item is resized;
8) a character or background item is flipped right-left or up-down; and/or
9) a character or background item is rotated.

An event-based storyline navigation mechanism 291 allows an author to jump forward or jump backwards to a particular event. For instance, a user might navigate through the various story changes by jumping forward or backwards until the story change is found.

An event editing mechanism 292 allows a user to edit the particular event navigated to using the event-based storyline navigation mechanism 291. There might be, for example, an event indicator displayed associated with the event. For instance, a green ball with particular character or background item in it might mean that this event is associated with the start of the animation of the character or background item. A red ball with the character or background item in it might mean that this event is the stopping of the animation of the particular character or background item. A white ball with the character in it might represent an event in which the character appears in the story. A white ball with the character in it and with an X over it might represent an event in which the character disappears from the story. A white ball with a character and an up or down arrow over it might be associated with an event in which the character is resized. Other intuitive indicators may be used to other corresponding event types. Of course, these described indicators are just examples only.

Finally, a record and play control 295 allows the author to play the story, causing the story to unfold in real time within the story canvas 210, or record the story, allowing the author to make changes to the story.

Various components of an example interactive story generation user interface have been described abstractly with respect to FIG. 2. However, user interfaces that have only some of the components described with respect to FIG. 2 may still be within the scope of the invention as defined by the claims. FIGS. 3 and 4 illustrate a more concrete example of a story generation user interface. In particular, FIG. 3 illustrates a canvas editing mode 300 of the user interface, and FIG. 4 illustrates a character creation mode 400 of the user interface.

In FIG. 3, the story canvas 310 is exposed. The story canvas 310 of FIG. 3 is a more concrete example of the story canvas 210 of FIG. 2. A creative author has already added some background to the story canvas. In particular, an author has directly drawn mountains 311A, 311B and 311C and a river 312 directly onto to the story canvas 310 using the paint palette control 320. The paint pallet control 320 is an example of a background generation mechanism 220 of FIG. 2. The paint palette control 320 also includes a control 321 that allows the author to expose and hide the paint palette control 320. Thus, when the paint palette 320 is exposed, the author may use the paint palette to create background and characters, and when the paint palette 320 is closed, the author might see more of the story canvas 310. The story canvas 310 is not illustrated in FIG. 4. However, the story canvas 310 might be displayed in lighter or otherwise deemphasized form behind the displayed components of FIG. 4.

Referring back to FIG. 3, the author has added more than just directly written background to the story canvas 310, but has also added other background items to the story canvas 310. For example, the author has copied objects from the story element library 330 into the story canvas 310. The story element library 330 is an example of the story element library 230 of FIG. 2. In this example, the author has actually drawn objects to include in the story element library 330. For instance, the story elements include a tree 331, a probable cat 332, a sun 333, a bird 334, a rain cloud 335, a stick figure man 336, and a moon 337.

The author might copy any one of the story elements in the story by perhaps dragging and dropping the character from the story element library 330 onto the story canvas. In this example, the author has copied four instances 331A, 331B, 331C and 331D of the tree 331 onto the story canvas 310. In addition, using this same mechanism, the story canvas also includes an instance 332A of the cat 332, an instance 333A of the sun 333, two instances 334A and 334B of the bird 334, and one instance 335A of the rain cloud 335. Once again, a copy of these background items may have been placed onto the story canvas 310 by dragging and dropping from the story element library 330. This dragging and dropping action from the story element library to the story canvas is an example of the story element selection mechanism 240 of FIG. 2. Since the story element library 330 includes background items (i.e., elements 331 through 335 and 337) and characters (i.e., element 336), this same process may be used to add both background items and characters to the story canvas.

The story element library 330 also includes a control 338 that allows the author to expose and hide the story element library 330. Thus, when the paint story element library 330 is exposed, the author may use the story element library to create view available background items and characters, and when the story element library 330 is closed, the author might see more of the story canvas 310.

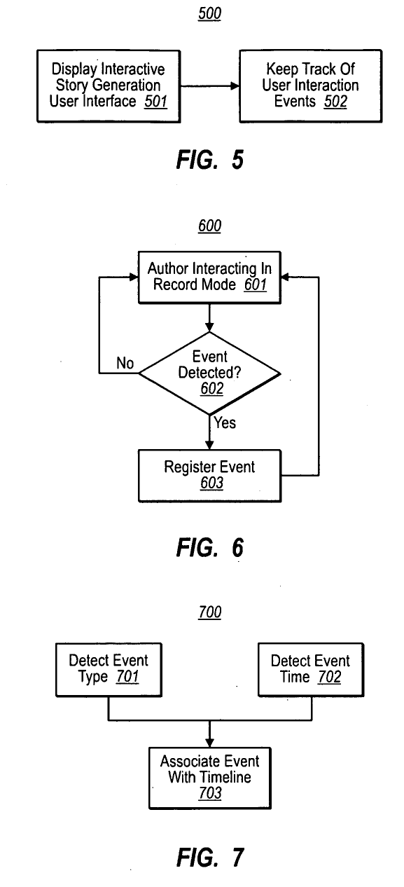

The story element library 330 also includes, in this case, a magic wand icon 339 that allows the author to transition from canvas editing mode 300 to character creation mode 400 of FIG. 4. The remaining items of FIG. 3 will be described with subsequent reference to FIGS. 5 through 8 and after the description of FIG. 4, which follows.

Referring to FIG. 4, the story canvas 310 is deemphasized or hidden. However, the paint palette 320 and the story element library 330 are shown. In addition, a character edit area 410 is shows along with edit controls 411, 412 and 413. The character edit area 410 is gridded to allow the author a more intuitive sense of relative scale. The character edit area 410 within the character creation mode 400 is an example of the story element authoring mechanism 250 of FIG. 2, and may be used to draw both characters and background items. Here, the user is drawing a stick figure man 431, which upon completion, can be added to the story element library 330.

If the author wishes to cancel the drawing without added any drawn content to the story element library 330, the author simply selects the cancel control 413. On the other hand, if the author wishes to add any drawing content to the story element library 330, the author would select the done control 412. The done control 412 is an example of the story element library addition mechanism 260 of FIG. 2.

However, the drawing edit area also allows the author to enter several frames of a character or background item, which when rendered in order, causes the character or background item to become animated in flip book style. After finishing entering one frame of the story element, the user would select the next control 411. This would result in the frame being saved, allowing the user to move to the next animation frame. In addition, the drawing from the prior frame is copied to the next frame. This allows the author to erase and redraw only the dynamic portions of the story element, thereby keeping the static portions of the character the same.

For instance, in FIG. 4, an animation summary field 420 illustrated to the left hand of the “equals” symbol (i.e., “=”) all of the frames 421 and 422 that have been entered for the animated story element. The window 423 to the right of the equals symbol might actually show the animation that is created by the frames 421 and 422 to the left. Thus, the window 423 might actually show the stick figure man 411 appearing to jump up and down by sequentially rendering the component frames 421 and 422 repeatedly.

In order to create the animation, the author selected the magic wand control 339 of FIG. 3, drew the first frame of the stick figure man 431 as illustrated in FIG. 4 with its arms and legs oriented downwards, selected the next control 411, erased only the arms and legs, redrew the arms and legs in the upward orientation, and then selected the done control 412 to add the now animated character to the story element library. In one embodiment, the distance between frames to the left of the equals symbol in the animation summary field 420 governs the time between rendering of each frame, and thereby governs the speed of animation. Thus, frames that are horizontally closer to their neighboring frame will be rendered with greater frequency than frames that are horizontally further from their neighboring frame.

Referring back to FIG. 3, the story canvas window 310 doubles as a portion of a story presentation window as well. The story presentation window 310 displays the story during playback. For instance, playback record control 342 may be used to enter playback mode in which the story is presented. In addition, the playback record control 342 may be used to enter record mode in which the user may engage with the story canvas 310 to edit the story. The canvas editing mode 300 also includes a timeline 351 with a timeline marker 352 positioned therein. The position of the timeline marker 352 represents the relative time of the current displayed image within the overall length of the entire story. Thus, in playback mode, unless the story is paused, the timeline marker 352 moves steadily from left to right in the timeline 351.

FIG. 5 illustrates a flowchart of a method 500 for the computer-aided assistance in story generation using a story generation interactive user interface. The method 500 includes the displaying (act 501) of an interactive story generation user interface on a display such as the interactive story generation user interface that allows an author to generate a story having a background and at least one character. An example of this user interface has just been described. In addition, the interface includes a story window that displays the story during playback. The interface also includes a timeline, and a timeline marker that is associated with the timeline at an appropriate time position corresponding to a portion of the story currently displayed in the story window.

In addition, the method 500 includes keeping track of events (act 502) associated with a number of different user interaction event types. Each user interaction event type corresponding to a particular kind of user interaction with the interactive story generation user interface. In particular, these interactive events may be tracked during record mode.

FIG. 6 illustrates a method 600 for keeping track of such events, and represents an example of how act 502 of FIG. 5 might be accomplished. Specifically, while the author is interacting with the interactive story generation user interface in record mode (act 601), there is an evaluation as to whether the user interaction constitutes an event that is to be registered (decision block 602). If not (No in decision block 602), the user interaction may continue (act 601). However, if an event is detected (Yes in decision block 602), then the event is registered (act 603).

FIG. 7 illustrates a flowchart of a method 700 for registering an event and represents one example of the event registration (act 603) of FIG. 6. Specifically, a user interaction event type of the detected user interaction event is identified (act 701). Also, an event time of the detected user interaction event is determined (act 702). In addition, the event is associated with the timeline 341 (act 703) in a manner that the event time becomes a navigation jump point in the timeline. As mentioned above, there are a number of different user interaction events that cause events to be registered on the timeline. Each registration results in a navigation jump point in the timeline. For instance, in the case of FIG. 4, the timeline 351 includes navigation jump points 361 through 367. If the author were to continue to interact, additional event navigation jump points may be displayed on the time line. FIGS. 6 and 7 are examples of the event detection mechanism 290 of FIG. 2.

An event visual element 370 is shown associated with the navigation jump point 361 by being displayed at or proximate that navigation jump point 361. In this case, the color and content of the circle 371 visually represents the type of event corresponding to that navigation jump point. The user might select the cancel control 372 to delete the effects of the event. For instance, if the event were the beginning of a character animation, deletion of the event would mean that the character is not longer animated, at least not until the beginning of some other character animation for that character. If the event were the appearance of a character, that character would not appear at that time if the event were deleted. If the event were the resizing of a character, the deletion of the event would mean that the character would not be resized at that time. The deletion of an event may cause the associated navigation jump point to be deleted as well. The deletion of an event in this manner is an example of the event editor 292 of FIG. 2.

These navigation jump points are generated in response to normal authoring of a story. The author need not be aware of the event system or the navigation jump points. Instead, if the author wants to edit an event, or navigate through the story, the author selects the jump backward control 341 or the jump forward control 343 to jump backward or forward to the next event or to the beginning or end of the story. As the user navigates forwards and backwards to each navigation jump point, the corresponding event visual element may be displayed, giving the author an idea of what types of event could be deleted at that point.

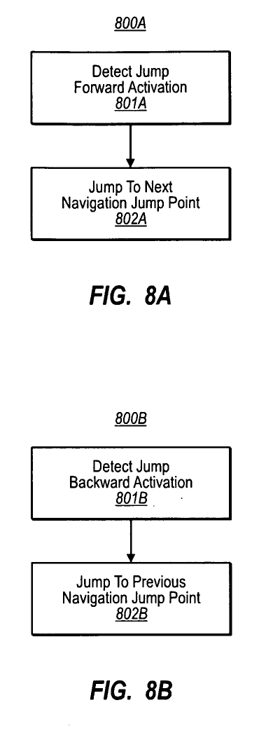

FIG. 8A illustrates a flowchart of a method 800A for navigating through the timeline in response to a jump forward navigation control activation. Upon detection of the jump forward navigation control button (act 801A), the timeline marker (and the displayed story) jumps forward (act 802A) in the timeline from a current position in the timeline to a next subsequent navigation jump point in the timeline.

FIG. 8B illustrates a flowchart of a method 800B for navigating through the timeline in response to a jump backwards navigation control activation. Upon detection of the jump backwards navigation control button (act 801B), the timeline marker (and the displayed story) jumps backward (act 802B) in the timeline from a current position in the timeline to a next prior navigation jump point in the timeline. FIGS. 8A and 8B are examples of the corresponding event-based navigation 291 of FIG. 2.

Although not shown in FIGS. 3 and 4, the user interface may also allow a control for beginning animation of a character or background item if flip book animation is available for the character. In addition, a speed control animation control may be used to control the speed of animation. In FIG. 4, as previously mentioned, this may be performed by controlling the spacing between frames in the animation summary field 420. However, the character may have other controls for controlling the speed of animation such that multiple instances of the same animated character or background item may have different speeds, or perhaps the same instance may change animation speed throughout the story.

In addition, a control may be placed at or near the play/record control that allows the author to toggle the voice record/mute modes. Thus, while recording a story, if the voice record mode is also active, the authors voice will be recorded for inclusion into the story. In addition, there might also be a feature that allows the user to select music or other background noise for the story. For example, for a jungle scene, jungle background sounds may be played. The beginning of a voice recording or music playing, and the end of voice recording or music playing may be other user interactions that cause events to be generated.

Accordingly, at least some embodiments described herein provide an intuitive tool that allows authors (such as children) to express themselves through stories. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising one or more physical computer-readable media having thereon computer-executable instructions that, when executed by one or more processors of a computing system, cause the computing system to render an interactive story generation user interface on a display, the interactive story generation user interface comprising:
a story element library that contains a plurality of story elements and that is available for multiple stories;
a story element selection mechanism that permits an author to select and include one or more of the plurality of story elements onto a story canvas for any one of the multiple stories;
a story element authoring mechanism that permits an author to generate reusable story elements that may be added to the story element library.

2. The computer program product in accordance with claim 1, wherein the generated reusable story elements includes at least one story item drawn by an author of at least one of the multiple stories.

3. The computer program product in accordance with claim 2, wherein the at least one drawn story item is a drawn story character.

4. The computer program product in accordance with claim 2, wherein the at least one drawn story item is a drawn background element.

5. The computer program product in accordance with claim 2, wherein the at least one story item comprises multiple frames of the story item which when rendered in sequence, results in a flip book style animation of the story character.

6. The computer program product in accordance with claim 5, wherein the interactive story generation user interface further comprises:
an animation activation mechanism for enabling and disabling the flip book style animation of the story character.

7. The computer program product in accordance with claim 5, wherein the interactive story generation user interface further comprises:
an animation speed control mechanism for controlling a speed of the flip book style animation of the story character.

8. The computer program product in accordance with claim 1, further comprising:
a voice integration mechanism configured to allow an author to record his or her voice, and include that voice in any of the multiple stories.

9. The computer program product in accordance with claim 1, further comprising:
a background generation mechanism for allowing an author to draw at least a portion of a story background directly onto the story canvas.

10. The computer program product in accordance with claim 1, further comprising:
an events detection mechanism, configured to detect when an author has engaged in any one of a plurality of input types; and
an event-based storyline navigation mechanism configured to allow an author to jump forward or jump backwards to a particular event; and
an event editing mechanism configured to allow a user to edit the particular event navigated to using the event-based storyline navigation mechanism.

11. A computer-assisted method comprising:
an act of displaying an interactive story generation user interface on a display that allows an author to generate a story having a background and at least one character, the interactive story generation user interface including a story window that displays the story during playback, a timeline, and a timeline marker that is associated with the timeline at an appropriate time position corresponding to a portion of the story currently displayed in the story window;
an act of keeping track of events associated with a plurality of user interaction event types, each user interaction event type corresponding to a particular kind of user interaction with the interactive story generation user interface;
while the author is interacting with the interactive story generation user interface, an act of detecting a plurality of user interaction events, and for each detected user interaction event, performing the following:
an act of determining a user interaction event type corresponding to the detected user interaction event;
an act of determining an event time of the detected user interaction event; and
an act of associating the event time in the timeline with the detected user interaction event in a manner that the event time becomes a navigation jump point in the timeline,
wherein in response to the act of detecting the plurality of user interaction events, the timeline includes a plurality of navigation jump points that each correspond to a corresponding event time.

12. The method in accordance with claim 11, further comprising:
in response to detecting a jump forward navigation control activation, an act of jumping forward in the timeline from a current position in the timeline to a next subsequent navigation jump point of the plurality of navigation jump points.

13. The method in accordance with claim 11, further comprising:
in response to detecting a jump backwards navigation control activation, an act of jumping backwards in the timeline from a current position in the timeline to a next prior navigation jump point of the plurality of navigation jump points.

14. The method in accordance with claim 11, further comprising:
an act of providing an event visual element at or proximate at least one of the plurality of navigation jump points in the timeline.

15. The method in accordance with claim 14, wherein the event visual marker displays in a manner that is dependent upon the user interaction event type corresponding to the navigation jump point.

16. The method in accordance with claim 14, wherein the event visual marker provides a mechanism to delete the user interaction event, thereby deleting the corresponding navigation jump point.

17. The method in accordance with claim 11, wherein at least one of the plurality of detected user interaction events comprises:
a user beginning to or ceasing to drag a story item in the story display to thereby create an animation of the dragged story item.

18. The method in accordance with claim 11, wherein at least one of the plurality of detected user interaction events comprises:
a user indicating a background change.

19. The method in accordance with claim 11, wherein at least one of the plurality of detected user interaction events comprises:
a user indicating a character resize or orientation change.

20. A computer program product comprising one or more physical computer-readable media having thereon computer-executable instructions that, when executed by one or more processors of a computing system, cause the computing system to render an interactive story generation user interface on a display, the interactive story generation user interface comprising:
a story element library that contains a plurality of story elements and that is available for multiple stories;
a story element selection mechanism that permits an author to select and include one or more of the plurality of story elements onto a story canvas for any one of the multiple stories;
a background generation mechanism for allowing an author to draw at least a portion of a story background directly onto the story canvas;
a story element authoring mechanism that permits an author to generate reusable story elements that may be added to the story element library, wherein the generated reusable story elements includes at least one flip book style animated character or background item drawn by an author of at least one of the multiple stories;
an events detection mechanism, configured to detect when an author has engaged in any one of a plurality of input types;
an event-based storyline navigation mechanism configured to allow an author to jump forward or jump backwards to a particular event; and
an event editing mechanism configured to allow a user to edit the particular event navigated to using the event-based storyline navigation mechanism.
